(19) United States
(12) Patent Application Publication
(10) Pub. No.: US 2026/0154717 A1
(43) Pub. Date: Jun. 4, 2026

(54) INVOICE QUALITY CONTROL USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Drogheda (IE)

(73) Assignee: Trilogy Enterprises, Inc., Austin, TX (US)

(21) Appl. No.: 19/378,043

(22) Filed: Nov. 3, 2025

Related U.S. Application Data
(60) Provisional application No. 63/714,904, filed on Nov. 1, 2024.

(51) Int. Cl. G06Q 30/04; G06N 5/022

(52) U.S. Cl. CPC G06Q 30/04; G06N 5/022

(57) ABSTRACT

A quality control system and method is disclosed which automates the quality control of invoices during invoice generation. The invoicing module of the quality control system receives the input data from the CRM platform. The prompt generator coupled with the invoicing module generates prompt based on the input data. The AI engine receives the prompt to classify and QC the input data to ensure completeness of the data. The validation module of the AI engine triggers invoice generation upon successful validation of the input data. The invoice provides real-time notifications or alerts to the user.

### CROSS-REFERENCE TO RELATED APPLICATION(S)

This application claims the benefit under 35 U.S.C. § 119(e) and 37 C.F.R. § 1.78 of U.S. Provisional Application No. 63/714,904, which is incorporated by reference in its entirety.

### FIELD OF THE INVENTION

The present invention relates in general to the field of electronics, and more specifically to artificial intelligence, in building AI-based quality control of invoices to automate the invoicing process that is utilized to check the quality of invoices in invoice generation.

### BACKGROUND OF THE INVENTION

An invoice processing system automates the handling of invoices from receipt to payment, ensuring accuracy and efficiency in financial transactions. Typically, the traditional invoicing system has relied on a manual data team to generate invoices. Though manual invoice processing ensures personal verification of data, it is time-consuming, and prone to human errors, thus leading to potential discrepancies in invoice generation. Manual invoicing allows control over data entry to protect privileged information better and avoid having to learn complicated software however, the manual input can lead to delayed invoice processing thus affecting the cash inflow.

Traditionally, semi-automated systems are utilized for invoice generation. Semi-automated systems utilize software for data entry with some level of automation. Typically, the semi-automated systems speed up the efficiency of the invoicing process by automating repetitive tasks and reducing time spent on manual entry, however, the semi-automation process offers only a marginal increase in processing speed as compared to the manual method. The semi-automated system automates certain aspects of the invoicing process but still requires manual intervention to validate the data which can still lead to inaccuracies.

Historically, rule-based systems have been utilized to automate the entire process of invoice generation. The rule-based system often involves a structured approach that uses predefined rules and logic to automate the invoicing process. The rule-based system ensures uniformity in invoice formatting and data entry, however, the rigidity in the rule-based system makes it difficult to handle exceptions or unique situations. Typically rule-based systems check the data against predefined criteria. However, the rule-based systems cannot perform real-time analysis and adjustments based on incoming data, potentially leading to outdated or incorrect invoicing.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts a quality control system to automate the quality control of invoices during invoice generation.

FIG. 2 depicts a quality control process utilized by the quality control system of FIG. 1.

FIG. 3 depicts a data structure for storage of information related to AI-enhanced invoices generated using an invoice generation system.

FIG. 4 represents an exemplary subscription activation process which is an embodiment of the quality control system.

FIG. 5 depicts a user interface to depict the output of the subscription activation which is an embodiment of a quality control system.

FIG. 6 depicts an exemplary network environment in which the system of FIG. 1 and the process of FIG. 2 may be practiced.

FIG. 7 depicts an exemplary computer system.

### DETAILED DESCRIPTION

A quality control system to automate the quality control of invoices during invoice generation is disclosed. The quality control (QC) system includes an invoicing module that receives input data. The input data 106 includes customer details, project milestone data, billing information, and contractual details. The invoice generation is triggered when the customer agrees to buy a product or service on the customer relationship management platform. The invoicing module receives the input data and provides the input data to a prompt generator. The prompt generator operatively coupled to the invoice module provides prompt to the AI engine to guide the AI engine to classify and perform QC on the input data to trigger the invoice generation.

The prompt include rules for the AI engine first to classify the input documents that the invoicing module receives. At first, the AI engine classifies the input documents by extracting quote details, and purchase order details from the documents. Once the AI engine classifies the documents. The AI engine processes the input data using a validation module. The validation module ensures completeness and accuracy to detect missing fields, validate data accuracy, and predict potential errors. The validation module upon successful validation automatically generates an invoice. The invoice then is provided to the customer thus providing real-time notifications.

Moreover, the quality control system can be utilized for auto-renewal of the subscription. The quality control system pulls the subscription details, verifies the terms and conditions for renewal against the contract, and automatically processes the invoice if everything is in order. Additionally, the quality control system ensures high accuracy as the AI engine checks for any discrepancies or anomalies in the input data.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

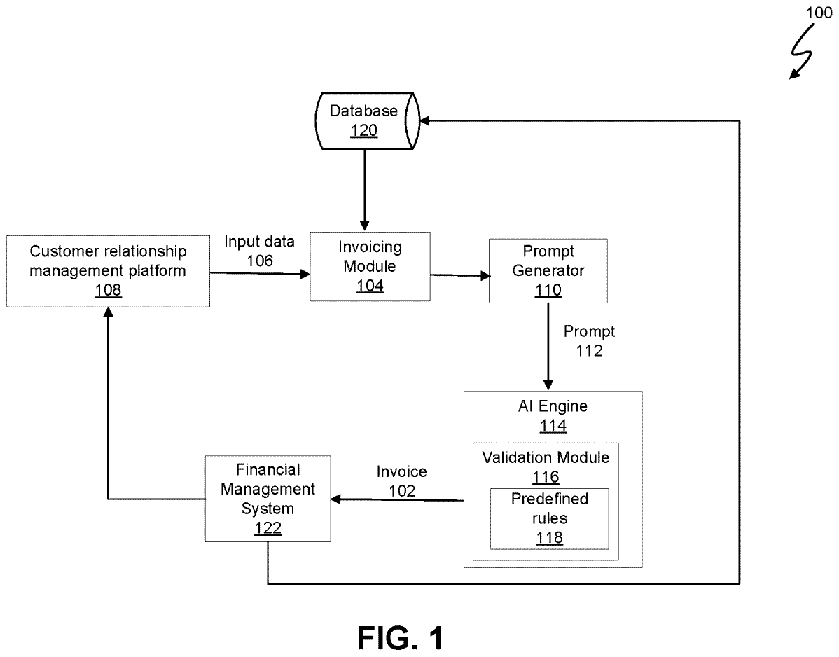

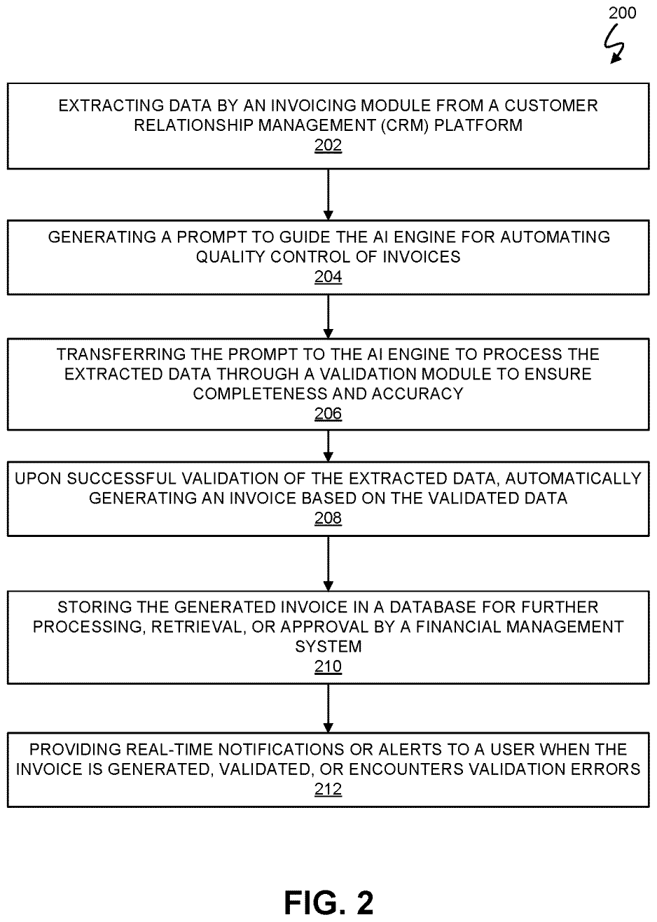

FIG. 1 depicts a quality control system 100 to automate the quality control of invoices 102 during invoice generation. FIG. 2 depicts a quality control process 200 utilized by the quality control system 100.

In operation 202, an invoicing module 104 receives input data 106 from a customer relationship management (CRM) platform 108. The input data 106 includes customer details, project milestone data, billing information, and contractual details.

The invoicing module 104 receives input data 106 from the customer relationship management platform 108. The customer relationship management platform 108 is a software tool that helps businesses manage and analyze customer interactions and data. In at least one of the embodiments, the customers can be any individual or organization that interacts with the business typically in purchasing capacity. The customer can be a current customer who has already made a purchase, a potential customer that has shown interest in companies products or services but have not yet made a purchase, or a former customer that have previously purchased the products or services but are no longer active. The customer relationship management platform 108 can be a sales and project management system, including Salesforce and Jira. Salesforce Inc. is an American cloud-based software company headquartered in San Francisco, California. JIRA is a popular project management and issue-tracking tool developed by Atlassian, and primarily used for agile software development. It helps teams plan, track, and manage software projects by providing features for issue tracking, project planning, and workflow customization.

The customer relationship management (CRM) platform 108 helps businesses manage their sales, customer service, marketing, and more. The CRM platform 108 allows automating processes, tracking customer interactions, and analyzing data to enhance customer relationships. The CRM platform 108 improves efficiency, boosts sales, and delivers personalized customer experiences.

Whenever a new sale is confirmed or the customer agrees to buy a subscription, a set of documents and records are typically created on the customer relationship management platform 108. These documents and records form the input data 106 which are utilized to track the details of the new deal whenever a new deal is closed. The input data 106 includes documents on customer details, project milestone data, billing information, and contractual details.

The customer details refer to the specific information that defines a customer. The customer details typically include the customer's name, contact information, address, account number, customer type, account status, industry, etc. Initially, the customer details are utilized to set up the account on the customer relationship management platform 108. Once the customer account is set up in the customer relationship management platform 108, the sales team creates an opportunity linked to that customer account. This opportunity represents the potential deal and includes details like the expected revenue, close date, and stage of the sales process. The project milestone data is defined once the opportunity is established. The project milestone data signify important achievements or phases in a project timeline. The project milestone data includes following information: contract signed, project kickoff, completion of deliverables, acceptance by the client, and final review. The project milestone data is identified during the planning phase of the project and is tracked as tasks in the customer relationship management platform 108.

Once the project planning is done the billing information is generated. The billing information is generated early on to clarify the payment terms and expectations often included in the opportunity record. The contractual details include the quote details, Purchase order, and approval document for the customer. The quote document includes detailed information on services, pricing and validity. The purchase order is issued by the customer based on the accepted quote confirming the order. The approval document is a signed document indicating the acceptance of the terms.

The invoicing module 104 extracts the input data 106 from the customer relationship management platform 108. The data extraction from the CRM platform 108 to the invoicing module 104 is performed via application programming interfaces (API). The API integration allows the invoicing module 104 to extract the input data 106 from the CRM platform 108.

For instance, a new deal for custom software development is created in the customer relationship management platform 108. The ‘customer details’ include the customer name: ‘Tech Innovations Inc., contact person: ‘Sarah Johnson’, email: sarah.j@techinnovations.com, Phone Number: (555) 123-4567, and Address: 456 Innovation Way, Suite 200, Tech City, TX 78901. The ‘project milestones data’ includes Project Kick-off: Jan. 15, 2024, Requirements Gathering: Jan. 20-Feb. 5, 2024, Design Phase: Feb. 6-Mar. 15, 2024, Development Phase: Mar. 16-May 30, 2024, Testing and QA: Jun. 1-Jun. 15, 2024, Project Delivery: Jun. 30, 2024. The ‘billing information’ includes the billing address: 456 Innovation Way, Suite 200, Tech City, TX 78901, Payment Terms: Net 30 days, Currency: USD, Total Amount: $50,000. The contractual terms include the Quote: Quote Number: Q-2024-001, Details: Service Description: Custom Software Development, Pricing: $50,000, Validity: Quote valid until Jan. 31, 2024, Attached to Opportunity: Yes, Purchase order PO Number: PO-2024-001, Issued By: Tech Innovations Inc., Date: Jan. 10, 2024, Reference Quote: Q-2024-001, Approval Document: Approval Date: Jan. 12, 2024, Signed By: Sarah Johnson (Tech Innovations Inc.), Terms Accepted: All terms as outlined in Quote Q-2024-00.

Once the customer agrees to the subscription, the input data and the subscription for the deal are analyzed to generate an invoice 102. The invoice 102 is a formal document detailing the products or services provided along with the amount due for the payment. It typically includes key components such as invoice number, date, seller and buyer information, descriptions of goods or services, subtotal, taxes, discounts, total amount due, and payment terms. Invoice 102 serve as a legal record and are essential for accounting and payment tracking.

In operation 204, a prompt generator 110 generates prompt 112 to guide the AI engine 114 to automate the quality control of invoices 102.

The prompt 112 sets the parameters for the AI engine 114 to automate the quality control of invoices 102, guiding the AI engine 114 to extract information from the input data 106 received. The information extraction includes the classification of the input data 106 into the quote, purchase order, and approval documents and the extraction of these details from the input data 106. The prompt(s) 112 are generated by prompt generator 110. The prompt generator 110 is operatively coupled to the invoicing module 104. The prompt generator 110 receives the extracted input data 106 from the invoicing module 104. The prompt generator 110 creates a structured or semi-structured set of instructions that serves as the input for the AI engine 114. The prompt 112 encapsulates the input data 106 to guide the AI engine 114 in processing the information and automates the quality control of invoices 102.

The AI engine 114 is responsible for processing the prompt 112 and automating the quality control of invoices 102. The prompt 112 generated by the prompt generator 110 acts as a set of instructions that guides the AI engine 114 in its decision-making process. The prompt 112 helps the AI engine 114 understand what task it is supposed to perform and how it should approach the problem or question at hand. The guidance provided by prompt 112 is essential for the AI engine 114 to automate the quality control of invoices 102. The prompt 112 generated by the prompt generator 110 acts as a set of instructions to check for the completeness of data fields required for invoicing. The quality control checks first involve the classification of the input data 106 and then comparing the subscription details to that of the input data 106. This matching is done to ensure that the subscription aligns with that of the customer to generate the invoice 102.

The exemplary prompt 112 to classify the input data 106 which in this case is different documents in the customer relationship management platform 108 along with the code is given below:

### AI Document Classification Prompt:

const prompt=
You are a document classification AI. You have been given a document to classify into one of the following categories: Quote, Purchase Order, Approval Document, Other.
Quote: A quote will have a quote number and a prepared date at the top, information about term start date, the items and total fee dues, as well as a section for signature and contract information.
Purchase Order: A purchase order will have a more variable format as they come from various customers, but they will always have a purchase order number at the start and other information.
Approval Document: Usually an image of a comment or an email from a member of the Finance team, stating that a customer has been approved to be invoiced via a purchase order or by a particular vendor.
Other: Any document that does not fit into the above categories.
;

The code ‘AI Document Classification Prompt’ starts with, “const prompt=You are a document classification AI”. The const prompt contains exemplary instructions for the AI engine 114 to classify the documents of input data 106 into the following categories including “Quote”, “Purchase Order”, “Approval Document” and Other. The AI engine 114 utilizes Textract to extract text from the input data 106 and classify the documents into the following types. Textract is a fully managed machine learning service provided by AWS (Amazon Web Services) that automatically extracts text, handwriting, and data from scanned documents. It goes beyond simple optical character recognition (OCR) by not only identifying text but also analyzing the layout and structure of documents, enabling it to extract tables, forms, and key-value pairs. Using Amazon Textract the documents are classified into various categories including purchase order, quote, and approval document.

The documents are classified based on a plurality of rules that determine the scenario applied to QC the document. The rules include counting the number of documents based on which the QC will be done. If the number of quote documents is greater than 1, then the documents will be QC for the previous quote and the product is QC for renewal of the subscription. If number of quotes=1 and the number of purchase orders=1, the QC case quote type will be for the signed quote and purchase order. If the number of quotes=1, then the QC case type will be for the signed quote. If the number of purchase orders=1 and the number of approval documents is more than 0, then the QC case type is PO with approval. If the number of purchase orders=1, then the QC case type is for PO only.

Below represents an exemplary prompt 112 to guide the AI engine 114 to extract quote details from the document.

### AI Quote Detail Extraction Prompt:

const prompt=‘
You are an AI that extracts quote details from a document.
Here are some rules to help you best identify which data to use:
   The service provider company is the name of the quote issuer, present in the file name at the top (usually followed by LLC) and in the Service Provider Address.
   The term start date is usually a date in DD-mmm-YYYY format.
   The term end date is usually a date in DD-mmm-YYYY format.
   The payment terms are usually, Due on receipt, Net 15, Net 30, Net 45, Net 60, etc.
   The billing schedule is often, 100% Upon Signature, Annually, Quarterly, Monthly, etc.
   The bill to and ship to addresses are the ones we have on record for the customer.
   The total fees due is the total amount due for the quote. Extract this as the raw number.
   Then add the currency symbol for currency.
   The items are the individual line items on the quote, with the item code and quantity.
   The signatures are in the above section, and either are transcribed signatures or image content.
There is a section after the basic information where the customer can provide optional information:
   PO Number: The purchase order number.
   Bill To: The bill to indication.
   Ship To: The ship to indication.
These can be left blank though.
’;

```
const quoteDetailsTool = {
  type: “function”,
  function: {
    name: “extractQuoteDetails”,
    description: “Extracts quote details from a document.”,
    parameters: {
      type: “object”,
      properties: {
        serviceProviderName: {
          type: “string”,
          description:
            “The name of the company providing. Appears usually near the
billing schedule and payment terms. Also appears in the PDF file name
usually.”,
        },
        customerCompanyName: {
          type: “string”,
          description: “The name of the customer company.”,
        },
        termStartDate: {
          type: “string”,
          description: “The term start date in DD-mmm-YYYY format.”,
        },
        termEndDate: {
          type: “string”,
          description: “The term end date in DD-mmm-YYYY format.”,
        },
        paymentTerms: {
          type: “string”,
          description: “The payment terms.”,
        },
        billingSchedule: {
          type: “string”,
          description: “The billing schedule.”,
        },
        billToAddress: {
          type: “string”,
          description: “The bill to address.”,
        },
        shipToAddress: {
          type: “string”,
          description: “The ship to address.”,
        },
        totalFeesDue: {
          type: “number”,
          description: “The total fees due.”,
        },
        currency: {
          type: “string”,
          description: “The currency symbol.”,
        },
        items: {
          type: “array”,
          items: {
            type: “object”,
            properties: {
              itemCode: {
                type: “string”,
                description: “The item code.”,
              },
              quantity: {
                type: “number”,
                description: “The quantity.”,
              },
            },
            additionalProperties: false,
            required: [“itemCode”, “quantity”],
          },
        },
        customerSignature: {
          type: “object”,
          properties: {
            isProvided:
              type: “boolean”,
              description:
                “Whether the customer signature is provided as a typed name,
docusign, or image content in CUSTOMER SIGNATURE section.”,
            },
            signature: {
              type: “string”,
              description: “The customer signature.”,
            },
          },
          additionalProperties: false,
          required: [“isProvided”, “signature”],
        },
        serviceProviderSignature: {
          type: “object”,
          properties: {
            isProvided: {
              type: “boolean”,
              description:
                “Whether a the service provider signature is provided as a
typed name, most often will be Andrew Price in SERVICE PROVIDER SIGNATURE
section.”,
            },
            signature: {
              type: “string”,
              description: “The service provider signature.”,
            },
          },
          additionalProperties: false,
          required: [“isProvided”, “signature”],
        },
      },
      additionalProperties: false,
      required: [
        “serviceProviderName”,
        “customerCompanyName”,
        “termStartDate”,
        “termEndDate”,
        “paymentTerms”,
        “billingSchedule”,
        “billToAddress”,
        “shipToAddress”,
        “totalFeesDue”,
        “currency”,
        “items”,
        “customerSignature”,
        “serviceProviderSignature”,
      ],
    },
  },
};
```

The prompt 112 starts with ‘const prompt=You are an AI that extracts quote details from a document’. The ‘const prompt also defines the rules to help in the extraction of quote details from the input data 106. The rules state the data type the AI engine 114 should utilize to extract the quote details from the documents. The rules include instructions related to date formatting, company name formatting, payment terms and various others.

The const prompt also defines a section where the customer provides the basic information including the PO number, bill to, ship to.

The extraction part includes reading the functions under the const quote details tool along with the description to extract quote details from the input data 106. The information to be extracted from the input data 106 includes ‘customerCompanyName’, ‘termStartDate’,‘termEndDate’, ‘paymentTerms’, ‘billingSchedule’, ‘billToAddress’, ‘shipToAddress’, ‘totalFeesDue’ ‘customerSignature’ ‘serviceProviderSignature’. This AI engine 114 analyzes this format and extracts the quote details in the same format. The validation module 116 of the AI engine 114 then provides quality checks to ensure the accuracy of the input data 106.

Below represents an exemplary prompt 112 to guide the AI engine 114 to extract Purchase order (PO) details from the documents of input data 106.

### AI PO Extraction Prompt:

const poPrompt=‘
You are an AI that extracts purchase order (PO) details from a document.
Here are some rules to help you identify which data to use:
   The PO Number is typically located at the top or near the beginning of the document and is a unique identifier.
   The Vendor Name is the name of the company or individual providing the service or goods.
   The Bill To address indicates where the invoice should be sent.
   The Ship To address indicates where the goods or services are to be delivered.
   The Term Start Date and Term End Date are usually in DD-MMM-YYYY format.
   The Currency indicates the currency in which the transaction is made (e.g., USD, EUR).
   The Total Fees Due is the total amount to be paid, usually located near the bottom of the document and expressed as a raw number.
   The Items section contains line items for the purchase order. Each item includes:
      Item Code: A unique identifier for the item.
      Quantity: The number of units for the item.
Ensure that all fields are extracted correctly and accurately.
’;

```
// Define the function tool for extracting PO details, including items
const poDetailsTool = {
  type: “function”,
  function: {
    name: “extractPODetails”,
    description: “Extracts purchase order details from a document.”,
    parameters: {
      type: “object”,
      properties: {
        poNumber: {
          type: “string”,
          description: “The purchase order number.”,
        },
        vendorName: {
          type: “string”,
          description: “The name of the vendor or service provider.”,
        },
        billTo: {
          type: “string”,
          description: “The bill-to address.”,
        },
        shipTo: {
          type: “string”,
          description: “The ship-to address.”,
        },
        termStartDate: {
          type: “string”,
          description: “The term start date in DD-MMM-YYYY
          format.”,
        },
        termEndDate: {
          type: “string”,
          description: “The term end date in DD-MMM-YYYY
          format.”,
        },
        currency: {
          type: “string”,
          description: “The currency symbol or code.”,
        },
        totalFeesDue: {
          type: “number”,
          description: “The total fees due.”,
        },
        items: {
          type: “array”,
          items: {
            type: “object”,
            properties: {
              itemCode: {
                type: “string”,
                description: “The item code.”,
              },
              quantity: {
                type: “number”,
                description: “The quantity of the item.”,
              },
            },
            additionalProperties: false,
            required: [“itemCode”, “quantity”],
          },
        },
      },
      additionalProperties: false,
      required: [
        “poNumber”,
        “vendorName”,
        “billTo”,
        “shipTo”,
        “termStartDate”,
        “termEndDate”,
        “currency”,
        “totalFeesDue”,
        “items”,
      ],
    },
  },
};
```

The prompt 112 starts with ‘const prompt=You are an AI that extracts quote details from a document’. The ‘const prompt also defines the rules to help extract quote details. The rules state the data type the AI engine 114 should utilize to extract the quote details from the documents. The rules include instructions related to date formatting, company name formatting

The const prompt also defines a section where the customer provides the basic information including the PO number, bill to, and ship to.

The extraction includes reading the functions under the const PO details tool along with the description to extract the quote details from the input data 106. The information to be extracted from the input data 106 includes ‘poNumber’, ‘vendorName’, ‘billTo’, ‘shipTo’, ‘termStartDate’, ‘termEndDate’, ‘currency’, totalFeesDue

Once the AI engine 114 classifies the documents the validation module 116 validates the input data 106 to ensure data correctness. The validation module 116 matches the subscription details to that of the input data 106 and ensures the correctness of the input data 106.

For instance, the AI engine 114 extracts and classifies the signed quote details from the input data 106, the validation module will QC the quote details from the extracted information.

Below represents an exemplary prompt 112 to guide the AI engine 114 to check if the signed quote input data 106 matches the subscription details to activate the subscription for invoice(ing) 102.

### Signed Quote QC Prompt.

const prompt=‘
You are an AI assistant to assist with determining whether a signed quote matches its subscription details so it can be activated for invoicing.
Some minor differences in phrasing or formatting, but it should still pass if they logically match. For example, US Dollar and
USD and $ all match for currency. Annually and Yearly match for billing schedule. For the subscription, an account ID will proceed the customer name that is not present on the quote.
Also check that there are signatures from both the customer and the service provider on the quote. This is not a comparison to the subscription, but a check that they are present.
Compare the following details and extract your decision using the QcDecisionTool, giving PASS or FAIL as your decision and your reasoning.
’;

```
export const qcSignedQuote = async (
  quoteDetails: ExtractedQuoteDetails,
  subscription: any,
  priceIntervals: any[ ],
  apikey: string
): Promise<OpenAiResult<QcDecision>> => {
  const totalValues = priceIntervals.map (
    (interval) => interval.totalintervalvalue || 0
  );
  const totalValue = totalValues.reduce((acc, val) => acc + val, 0);
  const comparison = {
    currency: {
      quote: quoteDetails.currency,
      subscription: subscription.currency.refName,
    },
    customer: {
      quote: quoteDetails.customerCompanyName,
      subscription:
        subscription.custrecord_subs_end_user.refName ||
        subscription.customer.refName,
    },
    startDate: {
      quote: quoteDetails.termStartDate,
      subscription: subscription.startDate,
    },
    endDate: {
      quote: quoteDetails.termEndDate,
      subscription: subscription.endDate,
    },
    totalValue: {
      quote: quoteDetails.totalFeesDue,
      subscription: totalValue,
    },
    subsidiary: {
      quote: quoteDetails.serviceProviderName,
      subscription: subscription.subsidiary.refName,
    },
    signatures: {
      customerSignature: quoteDetails.customerSignature,
      serviceProviderSignature: quoteDetails.serviceProviderSignature,
    },
  };
```

The signed quote QC prompt starts with const prompt=‘You are an AI assistant to assist with determining. The ‘const prompt also defines the rules to help extract quote details. The rules state the data type the AI engine 114 should utilize to extract the quote details from the documents. The rules include instructions related to date formatting and company name formatting. The rules for the AI engine 114 include even if there are minor differences in the formatting document. For instance, if USD is written on the input documents and on the subscription $ is written, the AI engine 114 should still match and pass the input documents for invoice processing. The validation module 116 of the AI engine 114 compares the subscription details to that of extracted documents to match the documents and then passes it for invoice processing.

Below represents an exemplary prompt 112 to guide the AI engine 114 to check if the purchase order aligns with the subscription details to activate the subscription for invoice(ing) 102.

### PO QC Prompt:

const prompt=‘
You are an AI assistant designed to verify whether a purchase order (PO) aligns with its subscription details for activation.
Your task is to compare the PO details with the subscription and price interval details to determine if they match logically. Consider minor variations in phrasing or formatting as acceptable if the meaning is consistent.
Perform the following checks:
   Verify that the currency in the PO matches the subscription (e.g., US Dollar, USD, $ are equivalent).
   Ensure that the PO's billing schedule aligns with the subscription's schedule (e.g., Annually and Yearly match).
   Compare the start and end dates, item details, and total fees due.
   Confirm the presence of necessary signatures from authorized personnel.
   Ensure the PO's vendor and subsidiary details match the subscription records.
   Check for any discrepancies that might prevent activation for invoicing.
Extract your decision using the QcDecisionTool, giving PASS or FAIL as your decision and your reasoning.
’;

```
export const qcPurchaseOrder = async (
  poDetails: ExtractedPODetails,
  subscription: any,
  priceIntervals: any[ ],
  apikey: string
): Promise<OpenAiResult<QcDecision>> => {
  const totalValues = priceIntervals.map(
    (interval) => interval.totalintervalvalue || 0
  );
  const items = priceIntervals.map((interval) => {
    return {
      itemCode: interval.item.refName,
      quantity: interval.quantity,
    };
  });
  const totalValue = totalValues.reduce((acc, val) => acc + val, 0);
  const comparison = {
    currency: {
      po: poDetails.currency,
      subscription: subscription.currency.refName,
    },
    vendor: {
      po: poDetails.vendorName,
      subscription: subscription.vendor.refName,
    },
    startDate: {
      po: poDetails.termStartDate,
      subscription: subscription.startDate,
    },
    endDate: {
      po: poDetails.termEndDate,
      subscription: subscription.endDate,
    },
    items: {
      po: poDetails.items, // Assuming ‘items‘ is a field in
ExtractedPODetails
      subscription: items,
    },
    totalValue: {
      po: poDetails.totalFeesDue,
      subscription: totalValue,
    },
    subsidiary: {
      po: poDetails.vendorName,
      subscription: subscription.subsidiary.refName,
    },
  };
  const comparisonString = JSON.stringify(comparison, null, 2);
  console.log(″Invoking QC on Comparison:″, comparisonString);
  return await getStructuredData<QcDecision> (
    prompt,
    comparisonString,
    qcDecisionTool,
    apiKey
  );
};
```

Similarly, the AI engine 114 processes the purchase order document to ensure that the purchase order aligns with the subscription details for the activation.

Below represents an exemplary prompt 112 to check approval to invoice from PO prompt.

Check Approval to Invoice from PO Prompt:
// Define the prompt for the AI
const approvalPrompt=‘
You are an AI designed to check whether approval has been granted to invoice from a Purchase Order instead of a signed quote.
You will be provided with the text of a Purchase Order and multiple Approval Documents. Analyze the documents to determine if explicit approval is mentioned.
Consider the following:
   Look for the approver being one of David Harpur, Rishap Ahuja, or Keval Karani, or a signature from a high ranking member of Finance.
   Look for keywords or phrases indicating approval, such as “approved for invoicing via PO”, “authorized to use PO”, etc.
   Ensure that the approval is specific to the context of invoicing from a PO.
   If no explicit approval is found, or if the documents are ambiguous, indicate that approval is uncertain.
Your task is to determine the approval status and provide reasoning for your conclusion.
’;

```
// Define the function tool for approval checking
const approvalCheckTool = {
  type: “function”,
  function: {
    name: “checkApprovalStatus”,
    description:
      “Determines if approval has been granted to invoice from a
Purchase Order instead of a signed quote.”,
    parameters: {
      type: “object”,
      properties: {
        status: {
          type: “string”,
          enum: [“Approved”, “Not Approved”, “Uncertain”],
          description:
            “The approval status: Approved, Not Approved, or
            Uncertain.”,
        },
        reasoning: {
          type: “string”,
          description:
            “The reasoning behind the approval status determination.”,
        },
      },
      additionalProperties: false,
      required: [“status”, “reasoning”],
    },
  },
};
```

Quote Comparison Prompt for Determining Differences between Auto-Renewal Quotes:
// Define the prompt for the AI to compare two quotes
const quoteComparisonPrompt=‘
You are an AI designed to analyze and compare two quotes. You need to determine the following:
1. Extract the preparation date for each quote.
2. Determine if the first quote is the new quote based on the preparation dates.
3. What is the total fees due for the previous quote, and what is its currency?
4. What is the total fees due for the new quote, and what is its currency?
5. Does the new quote have a multi-year term?
Here are some rules to help you identify the information:
   The preparation date is typically located at the top of the document.
   Compare the preparation dates to determine if the first quote is newer.
   The total fees due are generally found near the end of the quote in a summary or total section, often along with the currency symbol or code (e.g., USD, EUR).
   A multi-year term is indicated by a term length of more than one year in the quote or mentioned explicitly in the document.
Provide your analysis as follows:
   quotelPrepDate: The preparation date of the first quote.
   quote2PrepDate: The preparation date of the second quote.
   isQuotelNewQuote: true if the first quote is the new quote, false if it is the previous quote.
   previousQuoteTotalFees: The total fees due extracted from the previous quote.
   previousQuoteCurrency: The currency used in the previous quote.
   newQuoteTotalFees: The total fees due extracted from the new quote.
   newQuoteCurrency: The currency used in the new quote.
   newQuoteMultiYearTerm: true if the new quote has a multi-year term, false otherwise.
’;

```
// Define the function tool for quote comparison
const quoteComparisonTool = {
  type: “function”,
  function: {
    name: “compareQuotes”,
    description: “Analyzes and compares two quotes to extract key
    details.”,
    parameters: {
      type: “object”,
      properties: {
        quote1PrepDate: {
          type: “string”,
          description: “The preparation date of the first quote.”,
        },
        quote2PrepDate: {
          type: “string”,
          description: “The preparation date of the second quote.”,
        },
        isQuote1NewQuote: {
          type: “boolean”,
          description:
            “True if the first quote is the new quote, false if it is the
previous quote.”,
        },
        previousQuoteTotalFees: {
          type: “number”,
          description: “The total fees due for the previous quote.”,
        },
        previousQuoteCurrency: {
          type: “string”,
            description: “The currency used in the previous quote.”,
        },
        newQuoteTotalFees: {
          type: “number”,
            description: “The total fees due for the new quote.”,
        },
        newQuoteCurrency: {
          type: “string”,
          description: “The currency used in the new quote.”,
        },
        newQuoteMultiYearTerm: {
          type: “boolean”,
          description: “True if the new quote has a multi-year term.”,
        },
      },
      additionalProperties: false,
      required: [
        “quote1PrepDate”,
        “quote2PrepDate”,
        “isQuote1NewQuote”,
        “previousQuoteTotalFees”,
        “previousQuoteCurrency”,
        “newQuoteTotalFees”,
        “newQuoteCurrency”,
        “newQuoteMultiYearTerm”,
      ],
    },
  },
};
```

The check approval to invoice from the PO prompt starts with ‘Define the prompt for the AI’. The prompt 112 includes some rules for the AI engine to analyze the documents for approval. The ‘function tool for approval checking’ defines a function to check if the approval has been granted to the invoice from a Purchase Order instead of a signed quote. This step is essential for the final processing of invoice generation.

In operation 206, transferring the prompt 112 to the AI engine 114 to process the input data 106 through a validation module 116 to ensure completeness and accuracy. Typically, the input data 106 is provided to the AI engine 114. The prompt 112 guides and constrains the AI engine 114 to validate the input data 106 based on predefined rules 118. The AI engine 114 interprets the predefined rules 118 and routes the input data 106 through the validation module 116 designed to check for missing data fields, validate accuracy, and predict potential errors. The validation module 116 enables streamlined, automated verification, minimizing the need for manual oversight. The validation module 116 is configured to detect missing data fields by verifying that all required data fields for invoicing, including customer information, pricing details, and delivery milestones, are populated. Typically, detecting missing fields refers to the ability of the validation module 116 to identify any gaps or omissions in the input data 106. Generally, the input data 106 contains essential fields that are mandatory for processing, such as customer names, billing addresses, product or service descriptions, pricing, delivery timelines, and so forth.

The missing information can hinder the processing and validation to generate invoice 102, delay payments, and disrupt workflow. For example, input data 106 cannot be properly linked to the right subscription details without customer information, potentially leading to payment issues. Missing pricing details can result in underpayment or even cause legal problems. Therefore, identifying missing fields is crucial to maintaining accuracy and ensuring smooth transaction processing.

The validation module 116 uses a checklist of required fields, which acts as a template to verify completeness. The validation module 116 compares the extracted information from the input data 106 to the subscription details to identify missing data fields. If a mandatory data field is empty, the AI engine 114 flags it as incomplete. In at least one embodiment, the AI engine 114 employs machine learning models trained on many invoices 102 to learn which data fields are typically required, enabling it to adapt dynamically to different invoice formats and detect omissions more accurately. The required data fields for invoicing are the specific elements of information that the extracted input data 106 must contain. The data fields include, but are not limited to, customer information, pricing details, and delivery milestones. The customer information identifies the buyer, pricing details reflect the financial transaction specifics and delivery milestones indicate the fulfillment of agreed-upon services or products. The data fields are essential for clear communication between the seller and the buyer such as the customer and are necessary to uphold legal and financial obligations.

The validation module 116 has predefined data fields that are mandatory for the invoicing process. The validation module 116 scans the input data 106, verifies that each required data field is filled in, and flags any missing information. If the data field is empty or contains insufficient data, the AI engine 114 prompt 112 for further information or corrects the error based on historical data patterns. Typically, the customer information includes the name, contact details, and address of the customer. The pricing details cover the cost breakdown of goods or services, including any taxes or discounts applied. The delivery milestones are specific points or conditions marking the completion or partial delivery of the agreed-upon service or goods. The customer information ensures that the invoice 102 is directed to the right entity. The pricing details specify the financial obligations, while the delivery milestones indicate the status or stage of fulfillment, which is often tied to payment schedules.

Moreover, the validation module 116 is configured to validate data accuracy by applying predefined rules 118. The predefined rules 118 include checking for consistency in pricing, compliance with contractual terms, and project delivery timelines. Validating data accuracy involves confirming that the input data 106 is correct and consistent with the expected standards and formats. This may involve verifying that prices, names, dates, and other details align with known values or contractual terms. The validation module 116 has a set of predefined rules 108, such as checking for formatting, comparing amounts to known price lists, and verifying dates. The AI engine 114 checks the input data 106 against the predefined rules 118. The predefined rules 118 are specific guidelines or conditions programmed into the validation module 116 that dictate how input data 106 should be evaluated. The predefined rules 118 cover criteria like pricing, contract terms, and delivery schedules. The predefined rules 118 serve as the benchmark against which the input data 106 is validated. The predefined rules 118 ensure that the input data 106 complies with company standards, legal regulations, and customer expectations, fostering consistency and transparency in business operations. The predefined rules 118 are coded into the validation module 116, and the input data 106 is checked against them. If the input data 106 meets all the criteria, it is marked as accurate and invoice 102 is generated. If it fails any of the checks, the AI engine 114 flags it for further review or even sends it back to the issuer for correction.

The predefined rules 118 include checking for consistency in pricing, compliance with contractual terms, and project delivery timelines. The consistency in Pricing ensures that the prices on the input data 106 match agreed-upon prices on the subscription details. The compliance with contractual terms verifies that the input data 106 aligns with the terms outlined in the contract, such as payment conditions, discounts, or penalties. The project delivery timelines check that the timing of delivery or services matches the agreed-upon schedule. The validation module checks 116 that each of these elements aligns with the predefined rules 118.

The validation module 116 is configured to predict potential errors by comparing the extracted input data 106 against historical invoice patterns and identifying deviations that may indicate anomalies or errors. Typically, predicting potential errors involves the AI engine 114 to foresee issues that may arise in the invoice based on patterns of previous mistakes or inconsistencies. The predictive error detection allows to catch issues before they cause problems. For example, if a pattern shows a frequent error in tax calculations, the validation module 116 can alert customer building a proactive error-correction environment. The AI engine 114 uses historical data on previous invoices to recognize common errors. When the new subscription is processed, the AI engine 114 compares them against these learned patterns and flags any data that deviates from the norm. The comparing refers to the process of checking current input data against past invoices. The historical comparison helps in identifying subtle patterns that might go unnoticed, such as frequent under-billing for a specific service, or consistent delays in invoicing for certain clients. These patterns provide insight into hidden issues.

In at least one embodiment, the AI engine 114 uses machine learning algorithms to analyze historical data, identifying standard patterns for different clients, products, and services. When a new invoice differs significantly from these patterns, the AI engine 114 flags it as a potential anomaly. Typically, identifying deviations refers to spotting any differences or irregularities in the input data 106 that do not match the expected patterns and may indicate mistakes. Once the validation module 116 detects a deviation, it further evaluates it based on its magnitude and context. Minor deviations may be flagged for review, while major discrepancies might trigger automatic rejection or correction suggestions.

In operation 208, upon successful validation of the extracted data, automatically generating the invoice 102 based on the validated data. The generated invoice 102 includes details such as transaction description, pricing breakdown, and payment terms. Once the AI engine 114 validates the extracted input data 106, upon such validation the information is used to create the invoice 102. Typically, mistakes in the invoices 102 can lead to payment delays, customer dissatisfaction, and potential legal issues. The validation ensures that any missing or incorrect data is addressed, so only fully vetted information is included in the final invoice 102, leading to smoother operations and better customer relationships. The validation process involves the validation module 116 within the AI engine 114 to check each data point against predefined rules 118. For instance, if the subscription details is based on a purchase order, the validation module 116 would ensure that prices match, quantities are correct, and all required fields, such as customer name, item descriptions, and totals, are filled out. Once this validation is complete and successful, meaning no errors or omissions are found, the data can move to the next stage, which is invoice generation.

After data validation, the AI engine 114 uses a template or structured format to compile the invoice 102. The template includes fields for essential details such as transaction descriptions, prices, and payment terms. The AI engine 114 fills in each field with the corresponding validated data. The generated invoice 102 includes details such as transaction description, pricing breakdown, and payment terms. The transaction description on invoice 102 is a concise summary of the items, services, or work provided, giving a clear overview of what the invoice 102 is billing for. The transaction description helps to keep track of the purpose of the invoice 102. Beneficially, the transaction description prevents confusion and disputes by helping the customer understand exactly what they are paying for. For example, if a company provides multiple services, a detailed description for each itemized transaction makes it easier to track expenses and to verify that the invoice 102 aligns with their expectations.

The pricing breakdown on the invoice 102 is a detailed listing of charges associated with each item or service provided. The pricing breakdown includes quantities, unit prices, subtotal amounts, and any applicable taxes or discounts. The transparent pricing breakdown gives the customer a detailed view of how the total amount is calculated, which builds trust by showing that all charges are justified. It also minimizes disputes, as customers can easily identify any discrepancies in quantity, unit price, or other aspects. During invoice generation, the AI engine 114 takes the validated pricing data ensuring consistency and accuracy and organizes it into an itemized format. If taxes or discounts apply, then the amounts are calculated based on pre-configured rules, adding them to the breakdown.

The payment terms specify the conditions under which payment is to be made for the invoiced amount. These terms usually include due dates, accepted payment methods, early payment discounts, late fees, and any other payment-related guidelines. The payment terms ensure timely payments by defining when and how payment should be made.

In operation 210, storing the generated invoice 102 in a database 120 for further processing, retrieval, or approval by a financial management system 122. Once the invoice 102 has been generated, the generated invoice 102 is stored in the database 120. The database 120 acts as a centralized repository for all transactional data, ensuring that each generated invoice 102 is preserved in an organized, accessible, and secure manner. Storing the invoices 102 in the database 120 enables them to be retrieved or processed further as needed and allows for integration with the financial management system 122, which can perform various actions such as reviewing, approving, or tracking the invoices 102.

Typically, storing the invoices 102 in the database 120 preserves a record of each financial transaction in a centralized and organized manner, which is essential for financial audits, reporting, and analysis. The database 120 enhances accessibility and retrieval efficiency, allowing faster retrieval of the invoice 102 when required. Additionally, storing the invoices 102 in a secure database 120 protects sensitive information, such as customer details and pricing, ensuring compliance with data protection regulations. Storing invoices 102 also enables integration with the financial management systems 122 to access to complete, accurate, and organized invoice records for further processing, approvals, and payment tracking.

In at least one embodiment, the generated invoices 102 are saved in a digital format (such as PDF or XML). The invoice 102 includes date, customer ID, and total amount. Each invoice entry in the database 120 includes both the invoice file and metadata fields that make it easier to search, retrieve, and categorize. Typically, further processing refers to any additional steps or actions applied to the invoices 102 after they've been stored in the database 120. The further processing may include reconciliation, tracking, data analysis, or even preparing invoices 102 for specific approval workflows, such as verifying amounts or verifying adherence to contractual agreements. The further processing can be achieved by linking the database 120 with the financial management system 122 that can access and manipulate stored data. When data is needed for reconciliation or report generation, the financial management system 122 can retrieve the relevant invoice records from the database 120, aggregate the necessary information, and display it in customer-friendly formats like dashboards or reports.

Moreover, retrieval refers to accessing the stored invoices 102 from the database 122 for review, reference, or operational use. The ability to retrieve invoices 102 easily is crucial for efficient operations and effective financial management. When invoices 102 are stored in an organized, searchable database 120, teams can quickly locate records needed for audits, customer inquiries, or internal reviews. Quick access to the invoices 102 also speeds up dispute resolution, allowing financial teams to promptly 112 address any concerns from customers or suppliers. To retrieve invoices 102, search functions are utilized within the database 120, the search function has specific criteria such as invoice dates, customer names, or amounts, making it easier to locate specific invoice 102.

The database 120 is linked directly with the financial management system 122, which manages the approval workflow. Once the invoice 102 is stored in the database 120, it enters a review queue, where designated approvers are notified to examine the invoice 102 details and, if necessary, compare it with purchase orders or contractual agreements. The integration of the database 120 with the financial management system 122 enables real-time data synchronization, meaning any updates made to invoices 102 are instantly reflected.

In operation 212, providing real-time notifications or alerts to customer when the invoice 102 is generated, validated, or encounters validation errors. Typically, delivering timely, actionable updates to relevant customer during each stage of the invoicing process. The real-time alerts are typically presented in the form of notifications, emails, or mobile alerts that prompt 112 the customer to take specific actions or simply stay informed about the progress of an invoicing task. The real-time alerts enhance operational efficiency by keeping relevant personnel informed of critical updates. Moreover, timely notifications allow the customer to respond immediately to any issues or errors, preventing minor issues from escalating into larger, costlier problems. This immediacy is particularly important in financial workflows, where delays can impact cash flow, customer satisfaction, and even regulatory compliance.

When invoice 102 is generated, validated, or flagged with errors, each of these events serves as a trigger point to push out the notification. The notifications are sent to designated customer through predefined channels, such as a dashboard, email, or mobile app. These alerts are customized according to customer roles and the type of update required; for example, finance team members might receive different notifications than project managers. When the generation of the invoice is completed, it sends notification to the customer, indicating that the invoice 102 has been successfully created to notify the customer regarding the invoice generation.

The AI engine 114 performs various checks on invoice 102, such as verifying totals, ensuring all data fields are completed, and confirming that prices align with contracts. Once invoice 102 passes these checks, it triggers an automated “Invoice Validated” notification, which is sent to the designated customer. The notification provides details about the validated invoice, such as the customer's name, amount, and invoice number, along with any relevant next steps, such as submitting it for approval.

During the validation process, the AI engine 114 checks the input data against a set of predefined rules 118. If it detects any discrepancies, missing information, or inconsistencies, it flags these issues as errors and generates an “Invoice Validation Error” notification. This notification is prioritized to reach relevant customer immediately, often marked as high importance to ensure prompt 112 attention. The message typically includes details about the specific errors encountered, helping customer quickly identify and resolve the issue. The real-time alerts contribute to improved customer satisfaction.

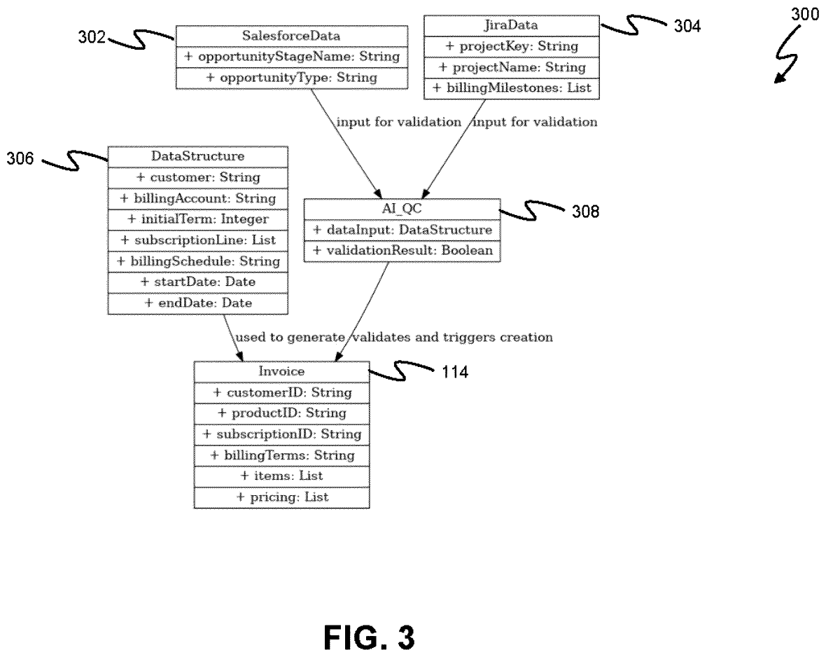

FIG. 3 depicts a data structure 300 for AI-enhanced invoice 102 generation using an invoice generation system 100.

The data structure 300 includes Salesforce data 302 node and Jira data 304 node which act as input data 106 for the AI engine 114 to validate the input data 106. The Salesforce data 302 node includes +opportunity stage name: string and +opportunity stage type: string. The opportunity stage name refers to the specific label assigned to the phase in the sales process such as ‘Closed won’ or ‘Closed lost’. The opportunity stage type categorizes the stages typically the sale is which includes Qualification,” “Proposal,” “Negotiation,” and “Closed. The ‘Closed won stage’ typically initiates the process of invoicing. For instance, when a customer agrees to buy the software subscription priced at $1,000. The opportunity stage changes to ‘closed won’ after the negotiation phase.

The Jira data 304 node includes +projectKey: String, +projectName: String, +billingMielstones: List. The ‘project key’ is a unique identifier in Jira, usually a short abbreviation or code (e.g., “DEV” for a development project). It is used in issue keys to distinguish issues belonging to different projects (e.g., DEV-123). The ‘project name’ is the full name of the project, providing a more descriptive label than the project key. For example, a project key “DEV” might have the project name “Website Development.” The ‘billing milestones’ refer to specific points in the project timeline where billing occurs, often tied to deliverables or phases in the project. For example, if a project has milestones like “Phase 1 Completion” and “Final Delivery,” these could be considered billing milestones if they trigger invoices or payments. The AI engine 114 then utilizes the input data 106 from Salesforce and Jira to validate the results to generate invoices 102 for the customer.

The AI engine 114 performs the AI_QC 308. The AI_QC 308 node includes +data input=data structure from Salesforce and Jira. The validation results are also stored upon quality checking of the input data 106.

The data structure 306 nodes include different nodes including the +customer: string, +billing Account: string, +initial term: Integer, +subscriptionLine: List, +billing schedule: string, +start date: date, +end date: date. This data includes details related to the customer. The AI engine 114 compares the data structure and validates the input data 106 which triggers the generation of invoice 102.

The generated invoice 102 includes +customer ID: string, +billing Account: string, +initial term: integer, +subscriptionID: string: List, +billingTerms: string, +items: List, +pricing: List. Invoice 102 can then be displayed to the customer to activate the subscription.

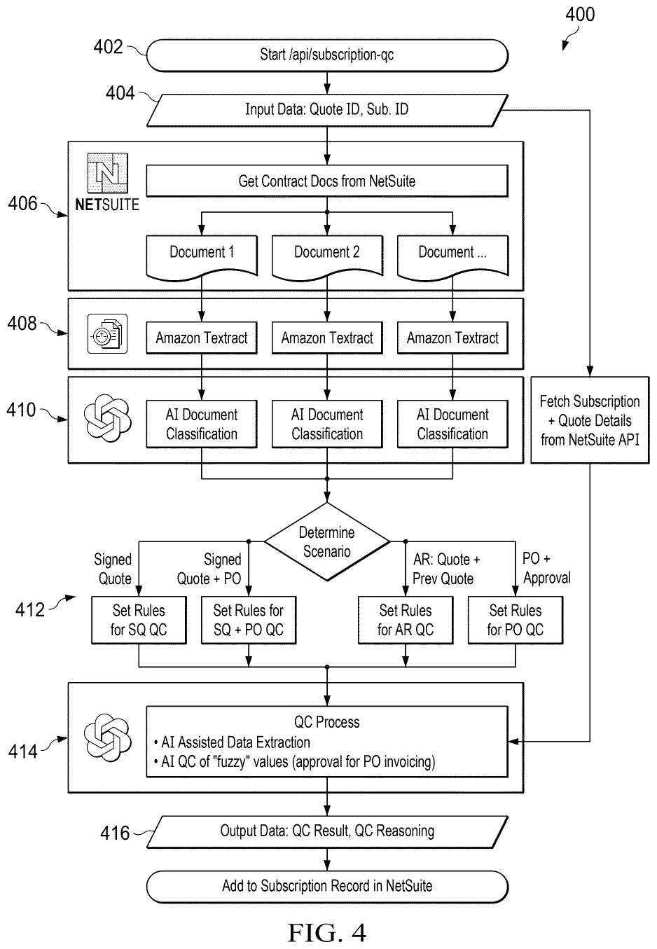

FIG. 4 represents an exemplary subscription activation process 400 which is an embodiment of the quality control system 100.

The subscription activation process 400 starts 402 when the customer agrees to buy a product or service. Once the customer agrees, the input data 404 including the quote ID and subscription ID is generated for the customer. The NetSuite 406 then includes all the documents containing customer details, billing information, project milestone data, and contractual details. Various documents in NetSuite 406 including document 1, document 2, and document 3 are the documents required to be processed to generate invoice 102. The documents are processed using Amazon Textract 408. The PDF content of the contractual documents is analyzed by Amazon Textract. The AI engine 114 initiates AI document classification 410 in which the documents are classified into Quote, Purchase order and approval document. Once the documents are classified different rules are set to QC the documents 412. An exemplary set of rules are set forth below below:

```
// Function to determine the QC case type based on document classification
export const getCaseType = (extractedValues: ExtractedValue[ ]): QcCaseType => {
  // Helper function to count the number of occurrences of each type
  const countType = (
    type: “Quote” | “Purchase Order” | “Approval Document” | “Other” | “Error”
  ): number =>
    extractedValues.filter((res) => res.classification.type === type).length;
  // Count the number of each type
  const numOfQuotes = countType(“Quote”);
  const numOfPurchaseOrders = countType(“Purchase Order”);
  const numOfApprovalDocuments = countType(“Approval Document”);
  const numOfOther = countType(“Other”);
  const numOfErrors = countType(“Error”);
  // Determine the case type based on the counts
  let qcCaseType: QcCaseType = “Other”;
  if (numOfErrors > 0) {
    qcCaseType = “Error”;
  } else if (numOfOther > 0) {
    qcCaseType = “Other”;
  } else if (numOfQuotes > 1) {
    qcCaseType = “QuotePrevQuote”;
  } else if (numOfQuotes === 1 && numOfPurchaseOrders === 1) {
    qcCaseType = “SignedQuoteAndPO”;
  } else if (numOfQuotes === 1) {
    qcCaseType = “SignedQuote”;
  } else if (numOfPurchaseOrders === 1 && numOfApprovalDocuments > 0) {
    qcCaseType = “PoWithApproval”;
  } else if (numOfPurchaseOrders === 1) {
    qcCaseType = “POOnly”;
  }
  return qcCaseType;
};
```

If the number of quote documents is greater than 1, then the documents will be QC for the previous quote and the product is QC for renewal of the subscription. If number of quotes=1 and the number of purchase orders=1, the QC case quote type will be for the signed quote and purchase order. If the number of quotes=1, then the QC case type will be for the signed quote. If the number of purchase orders=1 and the number of approval documents is more than 0, then the QC case type is PO with approval. If the number of purchase orders=1, then the QC case type is for PO only.

The validation module 116 of the AI engine 114 then QC the classified documents Based on these rules the validation module 116 classifies the documents. The prompt generator 110 provides prompt 112 to the AI engine 114 for the QC process 414. In at least one of the embodiments the OpenAI can be used for the QC process. Once the validation module 116 ensures the correctness of the data, the output data 416 is released on the customer relationship management platform 108. The output data 416 includes the QC result and QC reasoning. For instance, the QC result fails means that the input data 404 was not correct and the reasoning will provide the reasons for incorrectness. Moreover, if the input data 404 is correct, the validation module 116 triggers the invoice 102 generation and leads to the activation of the subscription.

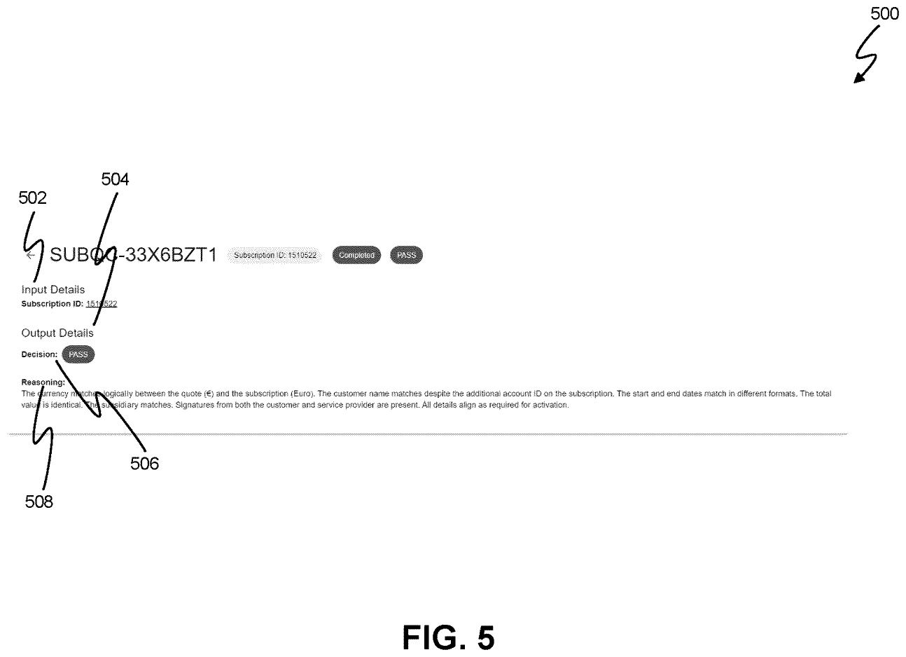

FIG. 5 depicts a user interface 500 to depict the output of the subscription activation which is an embodiment of quality control system 100.

The user interface 500 depicts input details 502 for which the invoice generation is triggered. For this subscription, the output details 504 are displayed on the customer relationship management platform 108. The decision ‘pass’ 506 indicates that the input details 502 have passed the QC check. The reasoning 508 is also displayed on why the input details have passed the QC check.

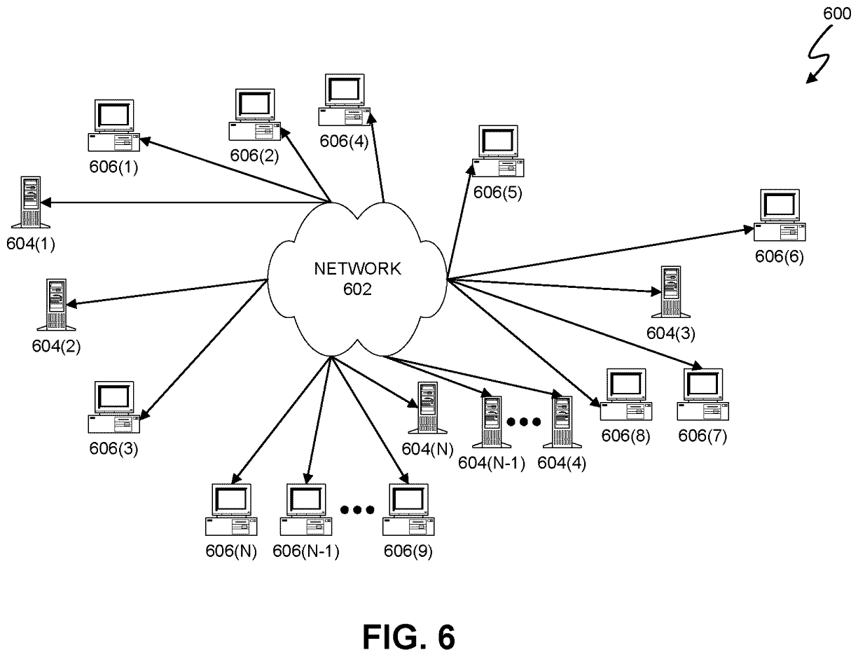

FIG. 6 is a block diagram illustrating a network environment in which a quality control system 100 and quality control process 200 may be practiced. Network 602 (e.g. a private wide area network (WAN) or the Internet) includes a number of networked server computer systems 604(1)-(N) that are accessible by client computer systems 606(1)-(N), where N is the number of server computer systems connected to the network. Communication between client computer systems 606(1)-(N) and server computer systems 604(1)-(N) typically occurs over a network, such as a public switched telephone network over asynchronous digital subscriber line (ADSL) telephone lines or high-bandwidth trunks, for example communications channels providing T1 or OC3 service. Client computer systems 606(1)-(N) typically access server computer systems 604(1)-(N) through a service provider, such as an internet service provider (“ISP”) by executing application specific software, commonly referred to as a browser, on one of client computer systems 606(1)-(N).

Client computer systems 606(1)-(N) and/or server computer systems 604(1)-(N) are specialized computer programmed to improve conventional computer systems to implement and utilize the quality control system 100 and quality control process 200. The type of computer system that can be specially programmed to implement and utilize the quality control system 100 and quality control process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the quality control system 100 and quality control process 200 can be implemented using code stored in a tangible, non-transient computer readable medium and executed by one or more processors. In at least one embodiment, the quality control system 100 and quality control process 200 can be implemented completely in hardware using, for example, logic circuits and other circuits including field programmable gate arrays.

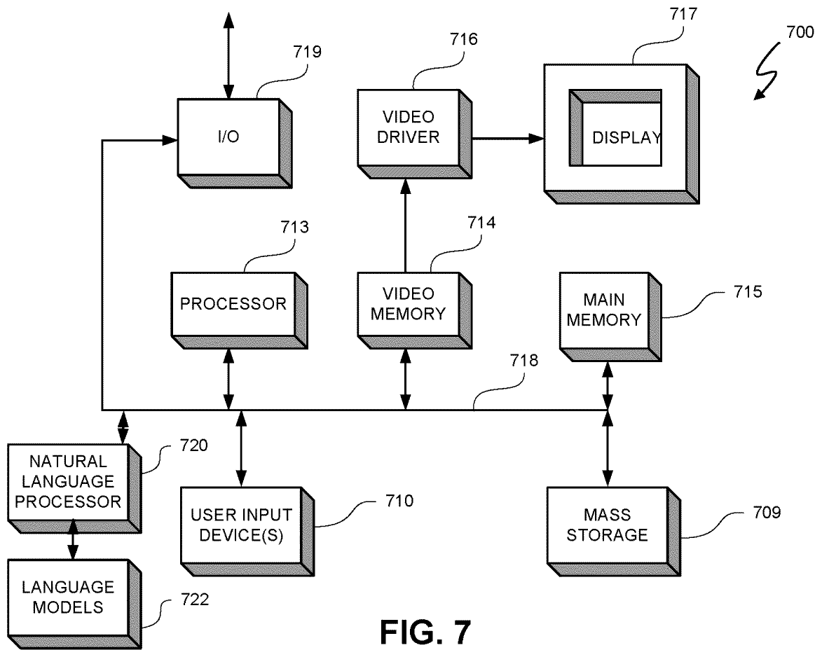

Embodiments of the quality control system 100 and quality control process 200 can be implemented on a computer system such as a special-purpose, special-programmed computer 700 illustrated in FIG. 7. Input user device(s) 710, such as a keyboard and/or mouse, are coupled to a bi-directional system bus 718. The input user device(s) 710 are for introducing user input to the computer system and communicating that user input to processor 713. The computer system of FIG. 7 generally also includes a non-transitory video memory 714, non-transitory main memory 715, and non-transitory mass storage 709, all coupled to bi-directional system bus 718 along with input user device(s) 710 and processor 713. The mass storage 709 may include both fixed and removable media, such as a hard drive, one or more CDs or DVDs, solid state memory including flash memory, and other available mass storage technology. Bus 718 may contain, for example, 32 of 64 address lines for addressing video memory 714 or main memory 715. The system bus 718 also includes, for example, an n-bit data bus for transferring DATA between and among the components, such as CPU 709, main memory 715, video memory 714 and mass storage 709, where “n” is, for example, 32 or 64. Alternatively, multiplex data/address lines may be used instead of separate data and address lines.

I/O device(s) 719 may provide connections to peripheral devices, such as a printer, and may also provide a direct connection to a remote server computer systems via a telephone link or to the Internet via an ISP. I/O device(s) 719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 709, into main memory 715 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 715 is comprised of dynamic random access memory (DRAM). Video memory 714 is a dual-ported video random access memory. One port of the video memory 714 is coupled to video amplifier 716. The video amplifier 716 is used to drive the display 717. Video amplifier 716 is well known in the art and may be implemented by any suitable means. This circuitry converts pixel DATA stored in video memory 714 to a raster signal suitable for use by display 717. Display 717 is a type of monitor suitable for displaying graphic images.

The computer system described above is for purposes of example only. The quality control system 100 and quality control process may be implemented in any type of computer system or programming or processing environment. It is contemplated that the quality control system 100 and quality control process 200 might be run on a stand-alone computer system, such as the one described above. The quality control system 100 and quality control process 200 [might also be run from a server computer systems system that can be accessed by a plurality of client computer systems interconnected over an intranet network. Finally, the quality control system 100 and quality control process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine for automating quality control of invoices in invoice generation comprising:
executing code using one or more processors of a computer system to cause the computer system to perform operations comprising:
extracting input data provided by a customer via an invoicing module from a customer relationship management (CRM) platform, wherein the input data includes customer details, project milestone data, billing information, and contractual details;
generating a prompt via a prompt generator to guide the AI engine for automating quality control of invoices;
transferring the prompt to the AI engine to process the input data through a validation module to ensure completeness and accuracy, wherein the validation module is configured to:
detect missing fields by verifying that all required data fields for invoicing, including customer information, pricing details, and delivery milestones, are populated;
validate data accuracy by applying predefined rules, wherein the predefined rules include checking for consistency in pricing, compliance with contractual terms, and project delivery timelines;
predict potential errors by comparing the extracted data against historical invoice patterns and identifying deviations that may indicate anomalies or errors;
upon successful validation of the extracted data, automatically generating an invoice based on the validated data, wherein the generated invoice includes details such as transaction description, pricing breakdown, and payment terms;
storing the generated invoice in a database for further processing, retrieval, or approval by a financial management system; and
providing real-time notifications or alerts when the invoice is generated, validated, or encounters validation errors.

2. The method of claim 1 wherein the input billing information includes payment terms and expectations often included in the opportunity record.

3. The method of claim 1 wherein the input data project milestone data includes task completion percentages, project deadlines, and deliverable statuses.

4. The method of claim 1 wherein the data extraction from the CRM platform to the invoicing module is performed via application programming interfaces (APIs).

5. The method of claim 1 further comprising:
configuring the predefined rules by a user, wherein the user can modify or predefined rules including pricing thresholds, contractual terms, and compliance guidelines based on requirements.

6. The method of claim 1 further comprising:
training the AI engine on historical invoicing data at a predefined frequency to adapt to evolving data patterns and improve the accuracy of error prediction in future invoices.

7. The method of claim 1 further comprising:
providing real-time notifications to the finance team when the invoice is generated and stored, wherein the notification includes the invoice details, validation results, and any discrepancies that were identified and resolved during the validation process.

8. The method of claim 1, wherein the AI engine detects errors by identifying deviations in the extracted data from predefined norms by comparing current data to historical patterns of similar transactions to detect anomalies such as pricing inconsistencies, incorrect milestone reports, or missing contractual terms.

9. A system for guiding an Artificial Intelligence (AI) for automating quality control of invoices in invoice generation comprising:
one or more processors of a computer system; and
a memory, coupled to the one or more processors, that stores code and execution of the code by the one or more processors causes the computer system to perform operations comprising:
extracting input data provided by a customer via an invoicing module from a customer relationship management (CRM) platform, wherein the input data includes customer details, project milestone data, billing information, and contractual details;
generating a prompt via a prompt generator to guide the AI engine for automating quality control of invoices;
transferring the prompt to the AI engine to process the input data through a validation module to ensure completeness and accuracy, wherein the validation module is configured to:
detect missing fields by verifying that all required data fields for invoicing, including customer information, pricing details, and delivery milestones, are populated;
validate data accuracy by applying predefined rules, wherein the predefined rules include checking for consistency in pricing, compliance with contractual terms, and project delivery timelines;
predict potential errors by comparing the extracted data against historical invoice patterns and identifying deviations that may indicate anomalies or errors;
upon successful validation of the extracted data, automatically generating an invoice based on the validated data, wherein the generated invoice includes details such as transaction description, pricing breakdown, and payment terms;
storing the generated invoice in a database for further processing, retrieval, or approval by a financial management system; and
providing real-time notifications or alerts to a user when the invoice is generated, validated, or encounters validation errors.

10. The system of claim 9 wherein the wherein the input billing information includes payment terms and expectations often included in the opportunity record.

11. The system of claim 9 wherein the extracted project milestone data includes task completion percentages, project deadlines, and deliverable statuses.

12. The system of claim 9 wherein the data extraction from the CRM platform to the invoicing module is performed via application programming interfaces (APIs).

13. The system of claim 9 wherein execution of the code by the one or more processors causes the computer system to perform further operations comprising:
configuring the predefined rules by the user, wherein the user can modify or predefined rules including pricing thresholds, contractual terms, and compliance guidelines based on requirements.

14. The system of claim 9 wherein execution of the code by the one or more processors causes the computer system to perform further operations comprising:
training the AI engine on historical invoicing data at a predefined frequency to adapt to evolving data patterns and improve the accuracy of error prediction in future invoices.

15. The system of claim 9 wherein execution of the code by the one or more processors causes the computer system to perform further operations comprising:
providing real-time notifications to the finance team when the invoice is generated and stored, wherein the notification includes the invoice details, validation results, and any discrepancies that were identified and resolved during the validation process.

16. The system of claim 9 wherein the AI engine detects errors by identifying deviations in the extracted data from predefined norms by comparing current data to historical patterns of similar transactions to detect anomalies such as pricing inconsistencies, incorrect milestone reports, or missing contractual terms.
